(19) United States
(12) Patent Application Publication
(10) Pub. No.: US 2014/0210961 A1
(43) Pub. Date: Jul. 31, 2014

(54) 3D DISPLAY SYSTEM AND DRIVING METHOD THEREOF

(71) Applicant: Shenzhen China Star Optoelectronics Technology Co. Ltd., Shenzhen Guangdong (CN)

(72) Inventor: Jhen-Wei He, Shenzhen City (CN)

(73) Assignee: Shenzhen China Star Optoelectronics Technology Co., Ltd., Shenzhen Guangdong (CN)

(21) Appl. No.: 13/818,831

(22) PCT Filed: Feb. 1, 2013
(86) PCT No.: PCT/CN2013/071262

§ 371 Date: Feb. 25, 2013

(30) Foreign Application Priority Data
Jan. 30, 2013 (CN) 201310036126.X

(51) Int. Cl. H04N 13/04

(52) U.S. Cl. CPC H04N 13/044; H04N 13/0438
USPC 348/53

(57) ABSTRACT

The present invention provides a 3D display system, which includes: shutter glasses and display device. The shutter glasses include driving device, and normally white liquid crystal panel and normally black liquid crystal panel, disposed overlappingly. The display device controls the ON duration of shutter glasses. Based on the ON duration, the driving device inquires to find the luminance amplification ratio corresponding to the ON duration and selects a driving manner based on the luminance amplification ratio. The driving manner includes driving only the normally black liquid crystal panel, or driving simultaneously both the normally black liquid crystal panel and the normally white liquid crystal panel. As such, the present invention can improve the commonality of the shutter glasses and save energy consumption.

### BACKGROUND OF THE INVENTION

1. Field of the Invention

The present invention relates to the field of displaying techniques, and in particular to a 3D display system and driving method thereof.

2. The Related Arts

Currently, the high-definition display device has become the mainstream of the market. The function of loading 3D display mode is a necessity for any large size display device. The current 3D display devices are mainly shutter type and polarized type, wherein the shutter type uses active shutter glasses to achieve the 3D display effect.

To achieve better 3D display effect, the active shutter glasses usually must have higher luminance. The known technique often uses two layers of liquid crystal panels, with one layer of normally black liquid crustal panel and one layer of normally white liquid crystal panel, to form shutter glasses so that the ON duration and the OFF duration of the shutter glasses can be at the rising time of the voltage applied to the liquid crystal panel to achieve the improvement of the luminance.

However, the shutter glasses of the known technique require two sets of voltage outputs to control the ON and OFF of the two layers of liquid crystal panel, which increases energy consumption. In particular, when the ON duration of the shutter glasses is longer the luminance contribution of the shutter glasses is limited. Therefore, the energy consumption is increased while the usage time of the shutter glasses is shortened.

### SUMMARY OF THE INVENTION

The technical issue to be addressed by the present invention is to provide a 3D display system and driving method thereof, able to reduce the energy consumption of the 3D display system and increase the commonality of the shutter glasses among different 3D display systems.

The present invention provides a driving method of 3D display system, the 3D display system comprising a pair of shutter glasses and a display device, the shutter glasses comprising a driving device and a normally white liquid crystal panel and a normally black liquid crystal panel, disposed overlappingly; the driving device pre-storing a mapping table of ON duration and luminance amplification ratio, the mapping table being mapping between the different ON duration of the shutter glasses and corresponding luminance amplification ratio, the driving method comprises: the display device providing display image to the shutter glasses and controlling the ON duration of the shutter glasses; predefining a threshold and determining whether the luminance amplification ratio corresponding to the ON duration being less than the threshold; when the result being yes, driving only the normally black liquid crystal panel; when the result being no, driving simultaneously both the normally black liquid crystal panel and the normally white liquid crystal panel, wherein the luminance amplification ratio satisfying the following equation:

$$A = \frac{S 1 - S 2}{S 1} or A = \frac{S 1 - S 2}{S 2}$$

wherein S1 being the luminance when driving both the normally black liquid crystal panel and the normally white liquid crystal panel, and S2 being the luminance when driving only the normally black liquid crystal panel; S1 and S2 corresponding to the same ON duration.

According to a preferred embodiment of the present invention, before the step of predefining a threshold and determining whether the luminance amplification ratio corresponding to the ON duration being less than the threshold, the method further comprises: inquiring the mapping table based on the ON duration to find the luminance amplification ratio corresponding to the ON duration.

According to a preferred embodiment of the present invention, the luminance is the total of the rays passing through the shutter glasses during the ON duration.

The present invention provides a driving method of 3D display system, the 3D display system comprising a pair of shutter glasses and a display device, the shutter glasses comprising a driving device and a normally white liquid crystal panel and a normally black liquid crystal panel, disposed overlappingly; the driving method comprises: the display device providing display image to the shutter glasses and controlling the ON duration of the shutter glasses; based on the ON duration, the driving device inquiring to find the luminance amplification ratio corresponding to the ON duration and selecting a driving manner based on the luminance amplification ratio, the driving manner comprising: driving only the normally black liquid crystal panel, or driving simultaneously both the normally black liquid crystal panel and the normally white liquid crystal panel.

According to a preferred embodiment of the present invention, the step of, based on the ON duration, the driving device inquiring to find the luminance amplification ratio corresponding to the ON duration and selecting a driving manner based on the luminance amplification ratio, the driving manner comprising: pre-storing a mapping table of ON duration and luminance amplification ratio, the mapping table being mapping between the different ON duration of the shutter glasses and corresponding luminance amplification ratio; and predefining a threshold and determining whether the luminance amplification ratio corresponding to the ON duration being less than the threshold; when the result being yes, driving only the normally black liquid crystal panel; when the result being no, driving simultaneously both the normally black liquid crystal panel and the normally white liquid crystal panel.

According to a preferred embodiment of the present invention, before the step of predefining a threshold and determining whether the luminance amplification ratio corresponding to the ON duration being less than the threshold, the method further comprises: inquiring the mapping table based on the ON duration to find the luminance amplification ratio corresponding to the ON duration.

According to a preferred embodiment of the present invention, the luminance amplification ratio satisfies the following equation:

$$A = \frac{S 1 - S 2}{S 1} or A = \frac{S 1 - S 2}{S 2}$$

wherein S1 is the luminance when driving both the normally black liquid crystal panel and the normally white liquid crystal panel, and S2 is the luminance when driving only the normally black liquid crystal panel; S1 and S2 correspond to the same ON duration.

According to a preferred embodiment of the present invention, the luminance is the total of the rays passing through the shutter glasses during the ON duration.

The present invention provides a 3D display system, which comprises: a pair of shutter glasses and a display device; wherein the shutter glasses comprising a driving device, and a normally white liquid crystal panel and a normally black liquid crystal panel, disposed overlappingly; the display device providing display image to the shutter glasses and controlling the ON duration of the shutter glasses; based on the ON duration, the driving device inquiring to find the luminance amplification ratio corresponding to the ON duration and selecting a driving manner based on the luminance amplification ratio, the driving manner comprising: driving only the normally black liquid crystal panel, or driving simultaneously both the normally black liquid crystal panel and the normally white liquid crystal panel.

According to a preferred embodiment of the present invention, the driving device further comprises a storing module, a determination module and a control module; wherein the storing module pre-stores a mapping table of ON duration and luminance amplification ratio, the mapping table being mapping between the different ON duration of the shutter glasses and corresponding luminance amplification ratio; the control module, based on the ON duration, inquires the mapping table to find the luminance amplification ratio corresponding to the ON duration and transmits to the determination module; the determination module predefines a threshold and determines whether the luminance amplification ratio corresponding to the ON duration being less than the threshold; when the result is yes, the control module drives only the normally black liquid crystal panel; when the result is no, the control module drives simultaneously both the normally black liquid crystal panel and the normally white liquid crystal panel.

According to a preferred embodiment of the present invention, the luminance amplification ratio satisfies the following equation:

$$A = \frac{S 1 - S 2}{S 1} or A = \frac{S 1 - S 2}{S 2}$$

wherein S1 is the luminance when driving both the normally black liquid crystal panel and the normally white liquid crystal panel, and S2 is the luminance when driving only the normally black liquid crystal panel; S1 and S2 correspond to the same ON duration.

According to a preferred embodiment of the present invention, the value of A decreases as the ON duration increases.

According to a preferred embodiment of the present invention, the luminance is the total of the rays passing through the shutter glasses during the ON duration.

The efficacy of the present invention is that to be distinguished from the state of the art. Based on the ON duration, the driving device of the shutter glasses inquires to find the corresponding luminance amplification ratio and, based on the luminance amplification ratio, selects a driving manner. The driving manner can be driving only the normally black liquid crystal panel, or driving simultaneously both the normally black liquid crystal panel and the normally white liquid crystal panel. Therefore, the present invention can control the driving manner of the shutter glasses according to different demands of different 3D display systems so that the shutter glasses can select to drive only the normally black liquid crystal panel, or drive simultaneously both the normally black liquid crystal panel and the normally white liquid crystal panel. Hence, the shutter glasses can be used with different 3D display systems and increases the commonality. In addition, when driving only the normally black liquid crystal panel, the energy consumption of the shutter glasses is reduced and the usage time of the shutter glasses is increased.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a 3D display system according to the present invention;

FIG. 2 is a schematic view showing the structure of the driving device of a 3D display system in FIG. 1;

FIG. 3 is a coordinate schematic view showing the relation of the ON duration and the luminance according to the present invention;

FIG. 4 is a flowchart of the driving method of the 3D display system according to the present invention; and

FIG. 5 is a flowchart of the specific driving method of the driving device of the 3D display system according to the present invention.

### DETAILED DESCRIPTION OF THE PREFERRED EMBODIMENTS

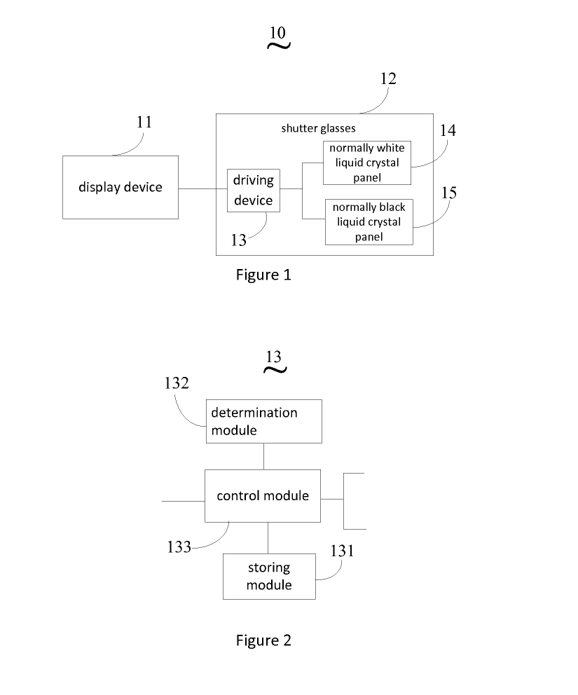

Referring to FIG. 1, FIG. 1 is a schematic view showing the structure of a 3D display system according to the present invention. As shown in FIG. 1, the 3D display system of the present invention comprises a display device 11 and a pair of a shutter glasses 12, wherein the shutter glasses 12 comprises a driving device 13, and a normally white liquid crystal panel 14 and a normally black liquid crystal panel 15, disposed overlappingly.

In the instant embodiment, the display device 11 provides display image to the shutter glasses 12 and controls the ON duration of the shutter glasses 12. The driving device 13 inquires to find the luminance amplification ratio corresponding to the ON duration and selects a driving manner based on the luminance amplification ratio, wherein the driving manner comprises: driving only the normally black liquid crystal panel 15, or driving simultaneously both the normally black liquid crystal panel 15 and the normally white liquid crystal panel 14. In the instant embodiment, driving only the normally black liquid crystal panel 15 is specifically to set the output voltage of the normally white liquid crystal display 14 as zero, and to output voltage only to the normally black liquid crystal panel 15. On the other hand, driving simultaneously both the normally black liquid crystal panel 15 and the normally white liquid crystal panel 14 is specifically to output voltage to both the normally black liquid crystal panel 15 and the normally white liquid crystal panel 14.

Specifically, also referring to FIG. 2, FIG. 2 is a schematic view showing the structure of the driving device of a 3D display system in FIG. 1. As shown in FIG. 2, the driving device 13 further comprises a storing module 131, a determination module 132 and a control module 133.

In the instant embodiment, the storing module 131 pre-stores a mapping table of ON duration and luminance amplification ratio. The mapping table shows mapping between the different ON duration of the shutter glasses and corresponding luminance amplification ratio.

In the instant embodiment, the luminance amplification ratio satisfies the following equation:

$$A = \frac{S 1 - S 2}{S 1} or A = \frac{S 1 - S 2}{S 2}$$

wherein S1 is the luminance when driving both the normally black liquid crystal panel 15 and the normally white liquid crystal panel 14, and S2 is the luminance when driving only the normally black liquid crystal panel 15; and S1 and S2 correspond to the same ON duration. The luminance is the total of the rays passing through the shutter glasses during the ON duration.

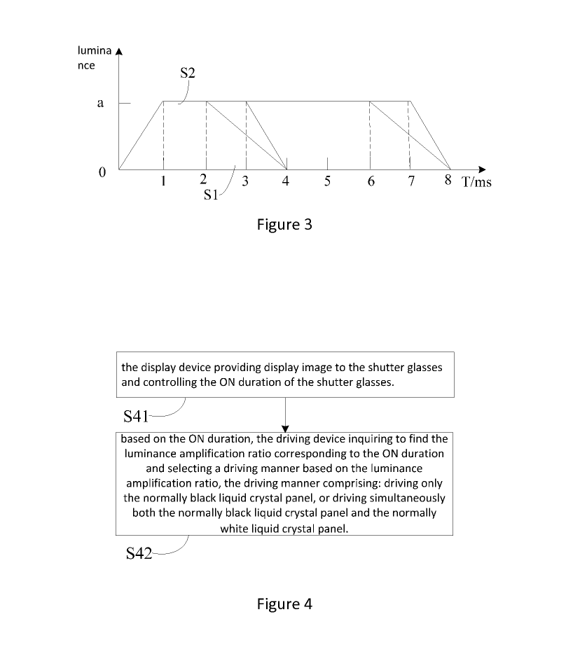

Also referring to FIG. 3, FIG. 3 is a coordinate schematic view showing the relation of the ON duration and the luminance according to the present invention. As shown in FIG. 3, the x-axis shows the ON duration T and y-axis shows the luminance, wherein the rays passing through the shutter glasses are maximum when the value of the luminance is “a”. In the instant embodiment, when driving simultaneously both the normally black liquid crystal panel 15 and the normally white liquid crystal panel 14, the response time of the shutter glasses 12 is assumed to be 1 ms; and when driving only the normally black liquid crystal panel 15, the response time of the shutter glasses 12 is assumed to be 1 ms and 2 ms respectively. When the ON duration T is 4 ms, the luminance of the shutter glasses 12 is the value of the area S1 in FIG. 3 when driving simultaneously both the normally black liquid crystal panel 15 and the normally white liquid crystal panel 14. As shown in FIG. 3, the value of S1 is:

$$S 1 = \frac{( 2 + 4 ) \times a}{2} = 3 a$$

Similarly, the luminance of the shutter glasses 12 is the value of the area S2 in FIG. 3 when driving only the normally black liquid crystal panel 15. As shown in FIG. 3, the value of S2 is:

$$S 2 = \frac{( 1 + 4 ) \times a}{2} = \frac{5 a}{2}$$

Therefore, when selecting equation

$$A = \frac{S 1 - S 2}{S 1}$$

to compute the luminance amplification ratio, with the ON duration of 4 ms, the luminance amplification ratio of the shutter glasses is:

$$A = \frac{S 1 - S 2}{S 1} = \frac{3 a - 5 a / 2}{3 a} = \frac{1}{6}$$

Similarly, the same method can be used to compute the luminance amplification ratio of the shutter glasses to be 1/4, 1/8, 1/10, 1/12, and 1/14 for the ON duration of 3 ms, 5 ms, 6 ms, 7 ms and 8 ms, respectively, and so on. A such, the mapping table of the ON duration and corresponding luminance amplification ratio in the instant embodiment is as shown in the following Table 1:

| | On Duration T (ms) | | | | | | |
|---|---|---|---|---|---|---|---|
| | 3 | 4 | 5 | 6 | 7 | 8 | . . . |
| Luminance | 1/4 | 1/6 | 1/8 | 1/10 | 1/12 | 1/14 | . . . |
| amplification | | | | | | | |
| ratio A | | | | | | | |

In the instant embodiment, when selecting equation

$$A = \frac{S 1 - S 2}{S 2}$$

to compute the luminance amplification ratio, with the ON duration of 4 ms, the luminance amplification ratio of the shutter glasses is:

$$A = \frac{S 1 - S 2}{S 2} = \frac{3 a - 5 a / 2}{5 a / 2} = \frac{1}{5}$$

Similarly, the same method can be used to compute the luminance amplification ratio of the shutter glasses to be 1/3, 1/7, 1/9, 1/11, and 1/13 for the ON duration of 3 ms, 5 ms, 6 ms, 7 ms and 8 ms, respectively, and so on. A such, the mapping table of the ON duration and corresponding luminance amplification ratio in the instant embodiment is as shown in the following Table 2:

On Duration T (ms)

| | 3 | 4 | 5 | 6 | 7 | 8 | . . . |
|---|---|---|---|---|---|---|---|
| Luminance | 1/3 | 1/5 | 1/7 | 1/9 | 1/11 | 1/13 | . . . |
| amplification | | | | | | | |
| ratio A | | | | | | | |

As shown in Table 1 and Table 2, the value of A decreases as the ON duration T increases.

It should be noted that when the ON duration is less than 3 ms, the ON duration is less than the response time for driving only the normally black liquid crystal panel 15. Therefore, the driving manner of driving simultaneously both the normally black liquid crystal panel 15 and the normally white liquid crystal panel 14 is selected. Table 1 and Table 2 are set by the developer according to the features of the shutter glasses 12 when manufacturing shutter glasses 12. For different shutter glasses 12, the response times of the normally black liquid crystal panel 15 and the normally white liquid crystal panel 14 are different. Therefore, the mapping in Table and Table 2 will also be different. The present invention does not impose any specific restriction here.

In the instant embodiment, the control module 133, based on the ON duration, inquires the mapping table to find the luminance amplification ratio corresponding to the ON duration and transmits to the determination module 132. The determination module 132 predefines a threshold and determines whether the luminance amplification ratio corresponding to the ON duration being less than the threshold; when the result is yes, the control module 133 drives only the normally black liquid crystal panel 15; when the result is no, the control module 133 drives simultaneously both the normally black liquid crystal panel 15 and the normally white liquid crystal panel 14.

It should be noted that the threshold in the present invention is defined by the user. In the instant embodiment, the threshold is preferably defined to be in the range of A=10%-20%. For example, as in Table 1, if the user defines the threshold as 1/9, when the display device 11 controls the On duration T of the shutter glasses 12 to be less than 6 ms, the corresponding luminance amplification ratio is all greater than the threshold 1/9. Therefore, the control module 133 drives simultaneously both the normally black liquid crystal panel 15 and the normally white liquid crystal panel 14. When the display device 11 controls the On duration T of the shutter glasses 12 to be greater than 6 ms, the corresponding luminance amplification ratio is all less than the threshold 1/9. Therefore, the control module 133 drives only the normally black liquid crystal panel 15.

In actual application, the user defines the threshold according to the features of the shutter glasses, such as the response times of the normally black liquid crystal panel 15 and the normally white liquid crystal panel 14. The present invention does not impose specific restriction here.

In the instant embodiment, the shorter the response times of the normally black liquid crystal panel 15 and the normally white liquid crystal panel 14 is, the smaller the luminance amplification ration of the shutter glasses 12 will be for the same ON duration. Therefore, when using the shutter glasses 12 with smaller luminance amplification ration, the threshold can be set as a smaller value. Correspondingly, when using the shutter glasses 12 with larger luminance amplification ration, the threshold can be set as a larger value.

Therefore, based on the luminance amplification ratio corresponding to the ON duration, the present invention can select to either drive only the normally black liquid crystal panel, or drive simultaneously both the normally black liquid crystal panel and the normally white liquid crystal panel. Hence, the shutter glasses can be used with different 3D display systems and increases the commonality. In addition, when driving only the normally black liquid crystal panel, the energy consumption of the shutter glasses is reduced and the usage time of the shutter glasses is increased.

The present invention further provides a driving method of 3D display system. The 3D display system comprises a display device and a pair of shutter glasses. The shutter glasses comprise a driving device and a normally white liquid crystal panel and a normally black liquid crystal panel, disposed overlappingly. Specifically, referring to FIG. 4, FIG. 4 is a flowchart of the driving method of the 3D display system according to the present invention. As shown in FIG. 4, the driving method of 3D display system comprises:

Step S41: the display device providing display image to the shutter glasses and controlling the ON duration of the shutter glasses.

Step S42: based on the ON duration, the driving device inquiring to find the luminance amplification ratio corresponding to the ON duration and selecting a driving manner based on the luminance amplification ratio, the driving manner comprising: driving only the normally black liquid crystal panel, or driving simultaneously both the normally black liquid crystal panel and the normally white liquid crystal panel.

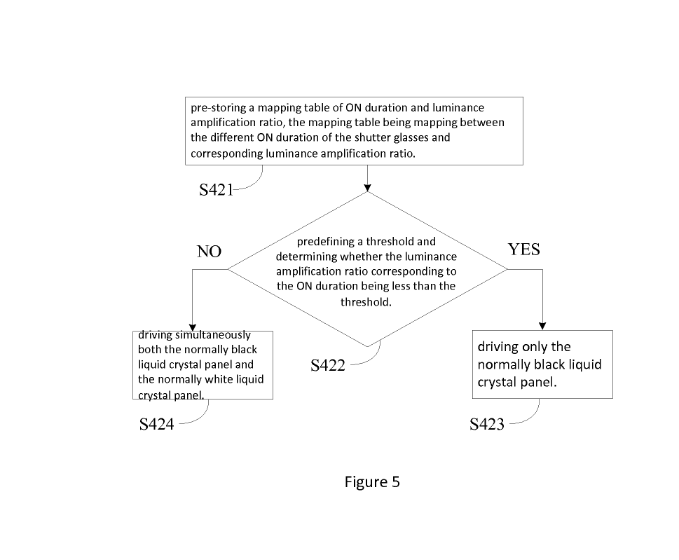

In the instant embodiment, the driving device of step S42 further performs steps to storing mapping table of ON duration and luminance amplification ratio, predefining threshold and determination of comparison. Specifically, referring to FIG. 5, FIG. 5 is a flowchart of the specific driving method of the driving device of the 3D display system according to the present invention. As shown in FIG. 5, step S42 of FIG. 4 further comprises the following steps:

Step S421: pre-storing a mapping table of ON duration and luminance amplification ratio, the mapping table being mapping between the different ON duration of the shutter glasses and corresponding luminance amplification ratio.

In step S421, the luminance amplification ratio satisfies the following equation:

$$A = \frac{S 1 - S 2}{S 1} or A = \frac{S 1 - S 2}{S 2}$$

wherein S1 is the luminance when driving both the normally black liquid crystal panel and the normally white liquid crystal panel, and S2 is the luminance when driving only the normally black liquid crystal panel; and S1 and S2 correspond to the same ON duration. The luminance is the total of the rays passing through the shutter glasses during the ON duration.

The specifics of constructing the mapping table of ON duration of the shutter glasses and corresponding luminance amplification ratio is as aforementioned, and will not be repeated here.

Step S422: predefining a threshold and determining whether the luminance amplification ratio corresponding to the ON duration being less than the threshold.

In the instant embodiment, before step S422, the mapping table is inquired to find the luminance amplification ration corresponding to the ON duration.

In step S422, when the result is yes, proceed to step S23; otherwise, proceed to step S424.

It should be noted that the threshold in the present invention is defined by the user. In the instant embodiment, the threshold is preferably defined to be in the range of A=10%-20%. For example, as in Table 1, if the user defines the threshold as 1/9, when the display device 11 controls the On duration T of the shutter glasses 12 to be less than 6 ms, the corresponding luminance amplification ratio is all greater than the threshold 1/9. Therefore, the control module 133 drives simultaneously both the normally black liquid crystal panel 15 and the normally white liquid crystal panel 14. When the display device 11 controls the On duration T of the shutter glasses 12 to be greater than 6 ms, the corresponding luminance amplification ratio is all less than the threshold 1/9. Therefore, the control module 133 drives only the normally black liquid crystal panel 15.

In actual application, the user defines the threshold according to the features of the shutter glasses, such as the response times of the normally black liquid crystal panel 15 and the normally white liquid crystal panel 14. The present invention does not impose specific restriction here.

In the instant embodiment, the shorter the response times of the normally black liquid crystal panel 15 and the normally white liquid crystal panel 14 is, the smaller the luminance amplification ration of the shutter glasses 12 will be for the same ON duration. Therefore, when using the shutter glasses 12 with smaller luminance amplification ration, the threshold can be set as a smaller value. Correspondingly, when using the shutter glasses 12 with larger luminance amplification ration, the threshold can be set as a larger value.

Step S423: driving only the normally black liquid crystal panel.

In step S423, driving only the normally black liquid crystal panel is specifically to set the output voltage of the normally white liquid crystal display as zero, and to output voltage only to the normally black liquid crystal panel.

Step S424: driving simultaneously both the normally black liquid crystal panel and the normally white liquid crystal panel.

In step S424, driving simultaneously both the normally black liquid crystal panel and the normally white liquid crystal panel is specifically to output voltage to both the normally black liquid crystal panel and the normally white liquid crystal panel.

In summary, the driving device of the shutter glasses of the 3D display system of the present invention determines the ON duration of the shutter glass and, based on the ON duration, the driving device inquires to find the corresponding luminance amplification ratio and compares the luminance amplification ration with a predefined threshold. When the luminance amplification ratio is less than the threshold, the shutter glasses drives only the normally black liquid crystal panel. When the luminance amplification ratio is larger than the threshold, the shutter glasses drives simultaneously both the normally black liquid crystal panel and the normally white liquid crystal panel. Hence, the shutter glasses can be used with different 3D display systems and increases the commonality. In addition, when driving only the normally black liquid crystal panel, the energy consumption of the shutter glasses is reduced and the usage time of the shutter glasses is increased.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A driving method of 3D display system, the 3D display system comprising a pair of shutter glasses and a display device, the shutter glasses comprising a driving device and a normally white liquid crystal panel and a normally black liquid crystal panel, disposed overlappingly; the driving device pre-storing a mapping table of ON duration and luminance amplification ratio, the mapping table being mapping between the different ON duration of the shutter glasses and corresponding luminance amplification ratio, the driving method comprises:
the display device providing display image to the shutter glasses and controlling the ON duration of the shutter glasses;
predefining a threshold and determining whether the luminance amplification ratio corresponding to the ON duration being less than the threshold;
when the result being yes, driving only the normally black liquid crystal panel; and
when the result being no, driving simultaneously both the normally black liquid crystal panel and the normally white liquid crystal panel, wherein the luminance amplification ratio satisfying the following equation:
$$A = \frac{S 1 - S 2}{S 1} or A = \frac{S 1 - S 2}{S 2}$$
wherein S1 being the luminance when driving both the normally black liquid crystal panel and the normally white liquid crystal panel, and S2 being the luminance when driving only the normally black liquid crystal panel; S1 and S2 corresponding to the same ON duration.

2. The driving method as claimed in claim 1, characterized in that before the step of predefining a threshold and determining whether the luminance amplification ratio corresponding to the ON duration being less than the threshold, the method further comprises:
inquiring the mapping table based on the ON duration to find the luminance amplification ratio corresponding to the ON duration.

3. The driving method as claimed in claim 1, characterized in that the luminance is the total of the rays passing through the shutter glasses during the ON duration.

4. A driving method of 3D display system, the 3D display system comprising a pair of shutter glasses and a display device, the shutter glasses comprising a driving device and a normally white liquid crystal panel and a normally black liquid crystal panel, disposed overlappingly; the driving method comprises:
the display device providing display image to the shutter glasses and controlling the ON duration of the shutter glasses; and
based on the ON duration, the driving device inquiring to find the luminance amplification ratio corresponding to the ON duration and selecting a driving manner based on the luminance amplification ratio, the driving manner comprising: driving only the normally black liquid crystal panel, or driving simultaneously both the normally black liquid crystal panel and the normally white liquid crystal panel.

5. The driving method as claimed in claim 4, characterized in that the step of, based on the ON duration, the driving device inquiring to find the luminance amplification ratio corresponding to the ON duration and selecting a driving manner based on the luminance amplification ratio, the driving manner comprises:
pre-storing a mapping table of ON duration and luminance amplification ratio, the mapping table being mapping between the different ON duration of the shutter glasses and corresponding luminance amplification ratio;
predefining a threshold and determining whether the luminance amplification ratio corresponding to the ON duration being less than the threshold;
when the result being yes, driving only the normally black liquid crystal panel; and
when the result being no, driving simultaneously both the normally black liquid crystal panel and the normally white liquid crystal panel.

6. The driving method as claimed in claim 6, characterized in that before the step of predefining a threshold and determining whether the luminance amplification ratio corresponding to the ON duration being less than the threshold, the method further comprises:
inquiring the mapping table based on the ON duration to find the luminance amplification ratio corresponding to the ON duration.

7. The driving method as claimed in claim 4, characterized in that the luminance amplification ratio satisfies the following equation:
$$A = \frac{S 1 - S 2}{S 1} or A = \frac{S 1 - S 2}{S 2}$$
wherein S1 is the luminance when driving both the normally black liquid crystal panel and the normally white liquid crystal panel, and S2 is the luminance when driving only the normally black liquid crystal panel; S1 and S2 correspond to the same ON duration.

8. The driving method as claimed in claim 7, characterized in that the luminance is the total of the rays passing through the shutter glasses during the ON duration.

9. A 3D display system, which comprises: a pair of shutter glasses and a display device; wherein:
the shutter glasses comprising a driving device, and a normally white liquid crystal panel and a normally black liquid crystal panel, disposed overlappingly;
the display device providing display image to the shutter glasses and controlling the ON duration of the shutter glasses;
based on the ON duration, the driving device inquiring to find the luminance amplification ratio corresponding to the ON duration and selecting a driving manner based on the luminance amplification ratio, the driving manner comprising: driving only the normally black liquid crystal panel, or driving simultaneously both the normally black liquid crystal panel and the normally white liquid crystal panel.

10. The 3D display system as claimed in claim 9, characterized in that the driving device further comprises a storing module, a determination module and a control module; wherein:
the storing module pre-stores a mapping table of ON duration and luminance amplification ratio, the mapping table being mapping between the different ON duration of the shutter glasses and corresponding luminance amplification ratio;
the control module, based on the ON duration, inquires the mapping table to find the luminance amplification ratio corresponding to the ON duration and transmits to the determination module;
the determination module predefines a threshold and determines whether the luminance amplification ratio corresponding to the ON duration being less than the threshold;
when the result is yes, the control module drives only the normally black liquid crystal panel; when the result is no, the control module drives simultaneously both the normally black liquid crystal panel and the normally white liquid crystal panel.

11. The 3D display system as claimed in claim 9, characterized in that the luminance amplification ratio satisfies the following equation:
$$A = \frac{S 1 - S 2}{S 1} or A = \frac{S 1 - S 2}{S 2}$$
wherein S1 is the luminance when driving both the normally black liquid crystal panel and the normally white liquid crystal panel, and S2 is the luminance when driving only the normally black liquid crystal panel; S1 and S2 correspond to the same ON duration.

12. The 3D display system as claimed in claim 11, characterized in that the value of A decreases as the ON duration increases.

13. The 3D display system as claimed in claim 11, characterized in that the luminance is the total of the rays passing through the shutter glasses during the ON duration.
